(19) United States
(12) Patent Application Publication
(10) Pub. No.: US 2021/0191149 A1
(43) Pub. Date: Jun. 24, 2021

(54) QUICK-CONNECT EYESHIELD ASSEMBLY

(71) Applicant: Veyes LLC, Carmel, IN (US)

(72) Inventor: Mark Allen Repko, Carmel, IN (US)

(21) Appl. No.: 16/723,574

(22) Filed: Dec. 20, 2019

(51) Int. Cl. G02C 3/02

(52) U.S. Cl. CPC G02C 3/02

(57) ABSTRACT

An eyeshield assembly is configured to couple to a brim of a head covering. The eyeshield assembly includes a base that is configured to couple to the brim of the head covering. A connector detachably couples to the base, and an eyeshield couples to the connector. A connecting structure detachably couples the connector to the base. The connecting structure includes a cantilevered tooth coupled to one of the base and the connector and a socket coupled to the other of the base and the connector. The socket selectively receives the cantilevered tooth to secure the connector to the base.

### TECHNICAL FIELD OF THE DISCLOSURE

The present disclosure relates to coupling devices for eyeshield assemblies, and more particularly, a coupling device for detachably connecting an eyeshield assembly to the brim of a head covering.

### BACKGROUND OF THE DISCLOSURE

When a person is outside on a sunny day wearing a head covering with a brim, there are times when the person wants to also wear sunglasses in order to provide additional protection for their eyes from the sunlight. In many use scenarios it may be advantageous to couple the eyeshield assembly to the underside of the brim of the head covering.

### SUMMARY OF THE DISCLOSURE

Eyeshield assemblies according to some embodiments of the present disclosure include features that facilitate easily attaching to a brim of a head covering, coupling securely to the brim of a head covering, and easily adjusting to the user's facial profile. Such features also facilitate easily detaching the eyeshield from the brim of the head covering when desired.

In one embodiment of the present disclosure, an eyeshield assembly is configured to couple to a brim of a head covering. The eyeshield assembly includes a base that is configured to couple to the brim of the head covering. A connector detachably couples to the base, and an eyeshield couples to the connector. A connecting structure detachably couples the connector to the base. The connecting structure includes a cantilevered tooth coupled to one of the base and the connector and a socket coupled to the other of the base and the connector. The socket selectively receives the cantilevered tooth to secure the connector to the base.

An eyeshield assembly according to the previous paragraph, wherein the connector couples to the cantilevered tooth and the socket couples to the base.

An eyeshield assembly according to any of the previous paragraphs, wherein the cantilevered tooth exits the socket and the connector slidably detaches from the base when a detachment force exceeds a threshold.

An eyeshield assembly according to any of the previous paragraphs, wherein the connector is slidably detachable from the base by translating in a first direction, the cantilevered tooth is pivotable relative to the one of the base and the connector about an axis, and the axis is substantially perpendicular to the first direction.

An eyeshield assembly according to any of the previous paragraphs, wherein the cantilevered tooth exits the socket and the connector slidably detaches from the base when a detachment force applied in the first direction exceeds a threshold.

An eyeshield assembly according to any of the previous paragraphs, wherein the cantilevered tooth includes an apex, the socket selectively receiving the apex to secure the connector to the base.

An eyeshield assembly according to any of the previous paragraphs, further including a plurality of sockets including the socket, each of the plurality of sockets individually selectively receiving the cantilevered tooth to secure the connector to the base.

In another embodiment of the present disclosure, an eyeshield assembly selectively couples to a base. The base is configured to couple to a brim of a head covering, and the base includes a socket. The eyeshield assembly includes an eyeshield and a connector coupled to the eyeshield. The connector is configured to detachably couple to the base. The connector includes a connector body and a slider support coupled to the connector body. The slider support is configured to slidably couple the connector to the base. A cantilevered tooth is coupled to the connector body, and the cantilevered tooth is configured to be selectively received in the socket to secure the connector to the base.

An eyeshield assembly according to the previous paragraph, wherein the cantilevered tooth includes an apex, and the apex is configured to be selectively received in the socket to secure the connector to the base.

An eyeshield assembly according to any of the previous paragraphs, wherein the connector is configured to slidably detach from the base by translating in a first direction, and the apex extends in a second direction substantially perpendicular to the first direction.

An eyeshield assembly according to any of the previous paragraphs, wherein the connector is configured to slidably detach from the base by translating in a first direction, the cantilevered tooth is pivotable relative to the connector body about an axis, and the axis is substantially perpendicular to the first direction.

In yet another embodiment of the present disclosure, a base for an eyeshield assembly is configured to couple to a brim of a head covering. The eyeshield assembly includes a connector that couples to an eyeshield, and the connector includes a cantilevered tooth. The base includes an attachment aperture that is configured to receive a fastener for coupling the base to the brim of the head covering. A slider support is configured to slidably receive the connector. A socket is configured to selectively receive the cantilevered tooth of the connector to secure the connector to the base.

An eyeshield assembly according to the previous paragraph, wherein the socket includes an inverse apex.

An eyeshield assembly according to any of the previous paragraphs, wherein the slider support facilitates translation of the connector in a first direction relative to the base, and the inverse apex extends in a second direction substantially perpendicular to the first direction.

An eyeshield assembly according to any of the previous paragraphs, further including a plurality of sockets including the socket, each of the plurality of sockets configured to individually selectively receive the cantilevered tooth to secure the connector to the base.

An eyeshield assembly according to any of the previous paragraphs, further including an arcuate upper surface configured to engage a lower surface of the brim of the head covering.

### BRIEF DESCRIPTION OF THE DRAWINGS

Advantages and features of the embodiments of this disclosure will become more apparent from the following detailed description of exemplary embodiments when viewed in conjunction with the accompanying drawings, wherein:

FIG. 1 is a top perspective view of an embodiment of an eyeshield assembly of the present disclosure in a use position, in a user's line of sight (LOS), and attached to a head covering;

FIG. 2 is a top perspective view of the eyeshield assembly of FIG. 1 in the use position;

FIG. 3 is a side sectional view of the eyeshield assembly along line 3-3 of FIG. 2, illustrating interaction of a latch and a pivot arm to maintain the assembly in the use position;

FIG. 4 is a top perspective view of the eyeshield assembly of FIG. 1 in a non-use position and disposed apart from the user's line of sight (LOS);

FIG. 5 is a side view of the eyeshield assembly of FIG. 1 in the non-use position;

FIG. 6 is a top perspective view of the eyeshield assembly of FIG. 1, illustrating an eyeshield and a connector detached from a base and the head covering;

FIG. 7 is a side sectional view of the eyeshield assembly along line 7-7 of FIG. 2, illustrating interaction of a cantilevered tooth and a socket to secure the connector and the eyeshield to the base;

FIG. 8 is a perspective sectional view of the eyeshield assembly along line 7-7 of FIG. 2;

FIG. 9 is a top perspective view of the base of the eyeshield assembly of FIG. 1;

FIG. 10 is a bottom perspective view of the base of FIG. 9;

FIG. 11 is a bottom view of the base of FIG. 9;

FIG. 12 is a front view of the base of FIG. 9;

FIG. 13 is a top perspective view of the connector of the eyeshield assembly of FIG. 1;

FIG. 14 is a bottom perspective view of the connector of FIG. 13;

FIG. 15 is a side view of the connector of FIG. 13;

FIG. 16 is a top view of the connector of FIG. 13;

FIG. 17 is a top perspective view of another embodiment of an eyeshield assembly of the present disclosure in a use position;

FIG. 18 is a bottom perspective view of yet another embodiment of an eyeshield assembly of the present disclosure in a use position; and

FIG. 19 is a top perspective view of the eyeshield assembly of FIG. 18, illustrating an eyeshield and a connector detached from a base.

### DETAILED DESCRIPTION OF THE DISCLOSURE

Eyeshield assemblies according to some embodiments of the present disclosure removably couple an eyeshield to a head covering. Such assemblies advantageously facilitate interchanging different types of eyeshields and/or reducing the weight carried by the head covering when use of an eyeshield is not desired. Eyeshield assemblies according to some embodiments of the present disclosure facilitate simple and quick transition from a use position of an eyeshield, in which a user wearing the eyeshield positions the eyeshield in front of their eyes to protect their eyes, to a non-use position, in which the user removes the eyeshield from his/her line of sight. It may be advantageous to transition an eyeshield to a non-use position, for example, when use of the eyeshield is temporarily undesirable. Eyeshield assemblies according to some embodiments of the present disclosure may also advantageously facilitate transitioning the eyeshield from the use position to the non-use position with substantially a hands-free operation.

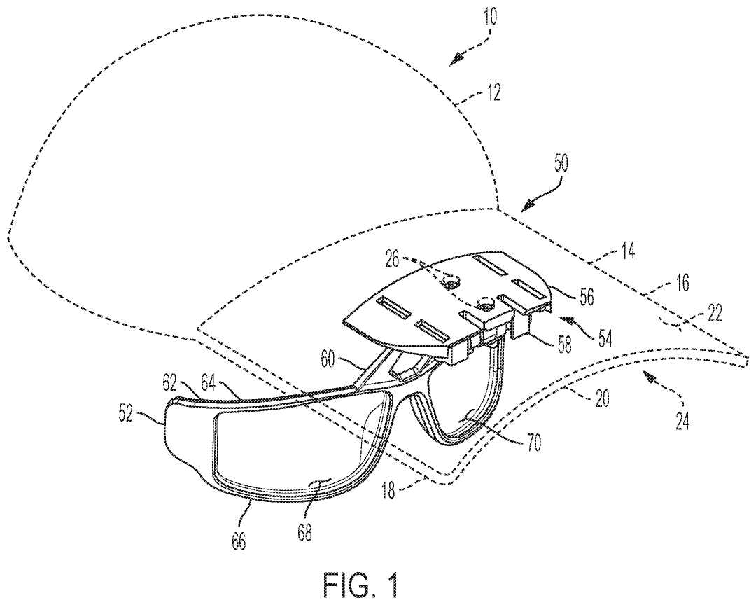

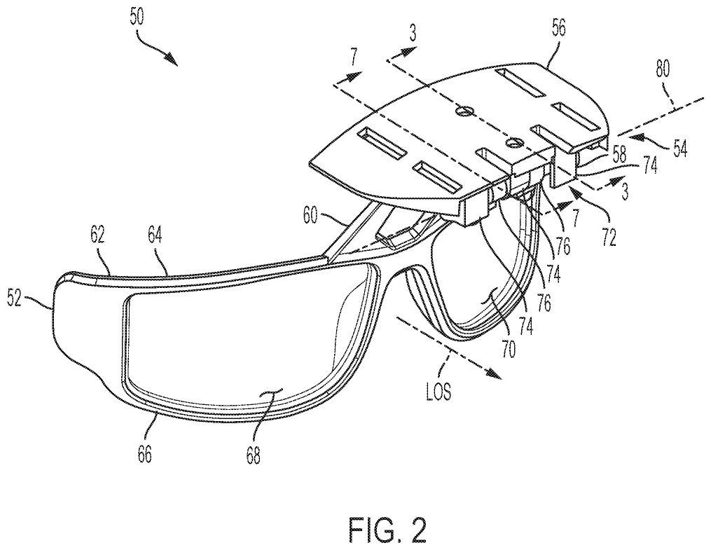

Referring to FIGS. 1 and 2, an embodiment of an eyeshield assembly 50 according to the present disclosure is illustrated. Referring specifically to FIG. 1, the eyeshield assembly 50 is generally configured to selectively couple an eyeshield 52 to a head covering 10 having a body portion 12, which fits over the head of a user, and a visor or brim 14, which projects away from the body portion 12. In various embodiments, the head covering 10 may be a baseball hat, visor, or any similar head covering 10. In an exemplary embodiment, the brim 14 extends forwardly from the user's face and serves to shade the user's eyes. Furthermore, the brim 14 may generally include a left edge 16, a right edge 18, a front edge 20, an upper surface 22, and a lower surface 24. Additionally, in various embodiments, the brim 14 may have a concave shape (more specifically, the upper surface 22 may be a convex surface and the lower surface 24 may be a concave surface) and/or may be constructed with a variety of dimensions and shapes.

Referring again to FIGS. 1 and 2, the eyeshield assembly 50 includes a quick-connector device 54 for selectively coupling the eyeshield 52 to the head covering 10. The quick-connector device 54 generally includes a base 56 that couples to the brim 14 of the head covering 10 (for example and as shown in FIG. 1, via fasteners 26) and a connector 58 that detachably and selectively couples to the base 56. Opposite the base 56, the connector 58 hingedly couples to a pivot arm 60, and the eyeshield 52 couples to the pivot arm 60 opposite the connector 58.

The eyeshield 52 generally includes a frame 62 having an upper edge 64 that couples to the pivot arm 60, and a lower edge 66 opposite the upper edge 64. In various embodiments, the frame 62 of the eyeshield 52 and the pivot arm 60 may generally be made from a resilient and lightweight material, such as plastic. In an exemplary embodiment, the frame 62 of the eyeshield 52 and the pivot arm 60 are molded as a unitary or monolithic component. The frame 62 carries one or more lenses between the upper edge 64 and the lower edge 66. In various embodiments and as illustrated, the eyeshield 52 includes a right lens 68 and a left lens 70 that are configured to be positioned in front of a user's right eye and left eye, respectively. In other embodiments, the eyeshield 52 may include a unitary lens (not shown) extending continuous between both of the user's eyes. In still other embodiments, the eyeshield 52 may include a single lens or an electronic device screen positioned in front of one, or both, of the user's eyes (that is, the eyeshield 52 may provide “smart glasses” or other types of electronic eyewear). The eyeshield 52 may be formed in any other configuration and shape. The lenses 68 and 70 may be tinted such that eyeshield 52 defines sunglasses. However, the lenses 68 and 70 may comprise a translucent or transparent material in any color or may be a clear translucent material such that the eyeshield assembly 50 may be configured for a plurality of applications. For example, in some embodiments, the entire eyeshield 52 may be formed of lens material, such as a transparent yellow plastic or a clear plastic (to provide, for example, protective eyewear). In these embodiments and others, the eyeshield 52 may lack lenses per se and one or more components of the frame 62, such as the upper edge 64 and lower edge 66. In some embodiments, the lenses 68 and 70 may be polarized.

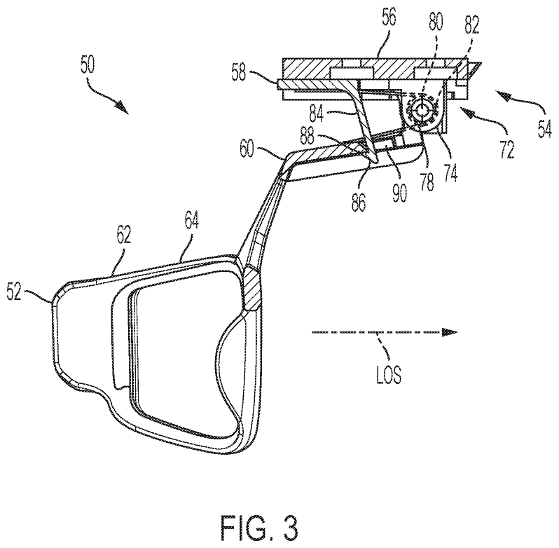

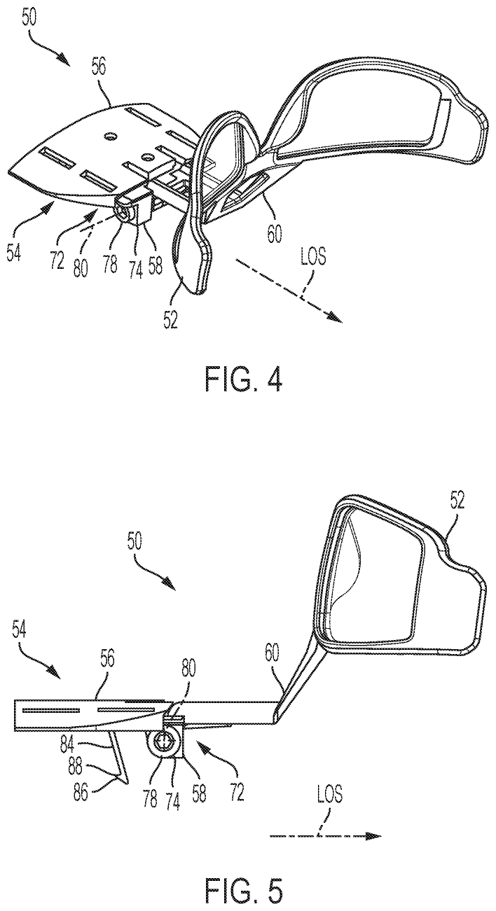

Referring now to FIGS. 2-5, the pivot arm 60 and the eyeshield 52 may pivot relative to the quick-connector device 54 and the head covering 10 (shown elsewhere). More specifically, the eyeshield 52 may pivot from a use or downward position, in which the eyeshield 52 is positioned in front of the user's eyes and within the user's line of sight (“LOS”—see FIGS. 2 and 3), to a non-use or upward position, in which the eyeshield 52 is positioned above the user's eyes and apart from the user's LOS (see FIGS. 4 and 5), and vice versa. Additionally, in the non-use position at least a portion of eyeshield 52 may be positioned forward of the front edge 20 of the brim 14 (shown elsewhere). In this way, when the eyeshield 52 is in the non-use position, the eyeshield 52 is fully and completely removed from under the lower surface 24 of the brim 14 (shown elsewhere) and extends forwardly and upwardly from the brim 14 such that eyeshield 52 does not interfere with the user's LOS. This positioning of the eyeshield 52 in the non-use position allows the user's LOS to be selectively unobstructed by the eyeshield 52.

With continued reference to FIGS. 2-5, to facilitate pivoting the eyeshield 52 from the use position to the non-use position and vice versa, the eyeshield assembly 50 includes a hinge assembly 72 that couples the connector 58 to the pivot arm 60. Generally, the hinge assembly 72 includes collars 74 and 76 formed by the connector 58 and the pivot arm 60, respectively. The collars 74 and 76 carry a shaft 78 that defines a pivot axis 80 about which the pivot arm 60 and the eyeshield 52 pivot relative to the connector 58. Referring specifically to FIG. 3, the hinge assembly 72 further includes a biasing element 82, illustratively a torsion spring carried by the shaft 78, that is pivotally compressed between the connector 58 and the pivot arm 60. The biasing element 82 biases the pivot arm 60 and the eyeshield assembly 50 away from the use position and toward the non-use position. The connector 58 further includes a latch 84 that selectively engages the pivot arm 60 to hold the pivot arm 60 and the eyeshield 52 in the use position and inhibit the biasing element 82 from pivoting the pivot arm 60 and the eyeshield 52 to the non-use position. More specifically and referring to FIGS. 3 and 5, the latch 84 includes a projection 86 having a shoulder 88 that extend through a latch opening 90 formed on the pivot arm 60. The shoulder 88 engages the pivot arm 60 to hold the pivot arm 60 and the eyeshield 52 in the use position. The latch 84 may be deflected and pivoted slightly away from the eyeshield 52 (as shown in FIG. 3, in a generally counterclockwise direction) to disengage the latch 84 from the pivot arm 60 and thereby permit the biasing element 82 to release stored energy and pivot the pivot arm 60 and the eyeshield 52 away from the use position and toward the non-use position.

The above components and other components of the hinge assembly 72 may be the same as or similar to the components of any of the hinge assemblies described in U.S. Pat. Nos. 10,048,509 or 10,444,535, the disclosures of which are hereby incorporated by reference in their entireties for all purposes. Alternatively, in other embodiments and as described in further detail below, eyeshield assemblies according to the present disclosure may include eyeshields that are non-pivotable relative to quick-connector devices and the head coverings.

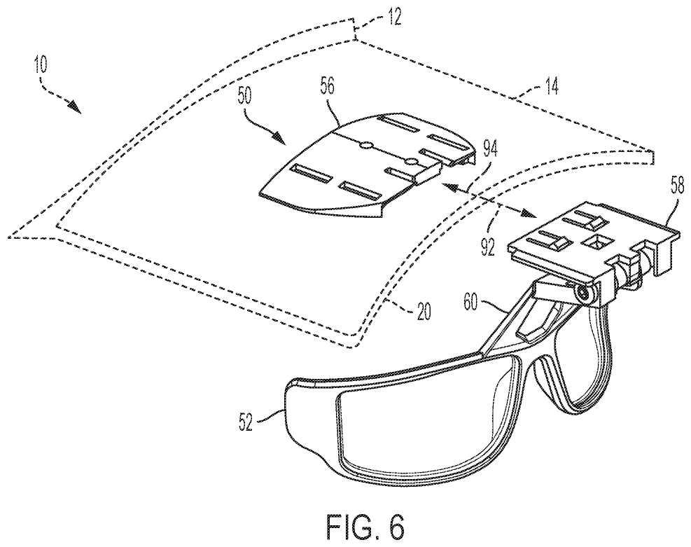

FIG. 6 illustrates the connector 58, the pivot arm 60, and the eyeshield 52 selectively detached from the base 56 and the brim 14 of the head covering 10. Generally, the connector 58 detaches from the base 56 by translating relative to the base 56 in a first or detachment direction 92. Conversely, the connector 58 attaches to the base 56 by translating relative to the base 56 in an attachment direction 94 opposite the detachment direction 92. In some embodiments and as illustrated, the detachment direction 92 extends generally away from the body portion 12 of the head covering 10 and toward the front edge 20 of the brim 14, and the attachment direction 94 extends generally toward the body portion 12 of the head covering 10 and away from the front edge 20 of the brim 14. In other embodiments, the detachment direction 92 and the attachment direction 94 may be oriented differently relative to the head covering 10.

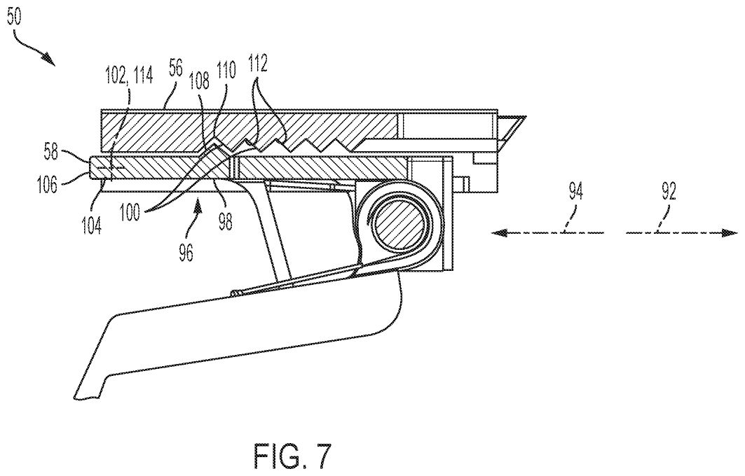

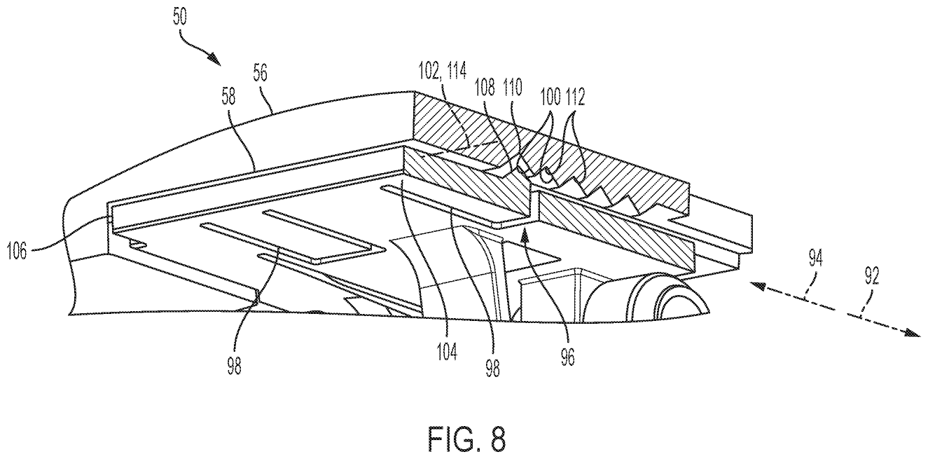

Referring to FIGS. 7 and 8, the base 56 and the connector 58 together define a connecting structure 96 for detachably coupling and selectively securing the components to each other. More specifically, the connecting structure 96 includes one or more cantilevered teeth 98 coupled to one of the base 56 and the connector 58. The connecting structure 96 also includes one or more sets of sockets 100 (a first set of sockets 100 is shown in FIGS. 7 and 8, and a second set of sockets 100 is shown elsewhere), each of which receives one of the cantilevered teeth 98 to secure the connector 58 to the base 56. Illustratively, the connector 58 includes the cantilevered teeth 98 and the base 56 includes the sets of sockets 100. Alternatively, the connector 58 may include the sets of sockets 100 and the base 56 includes the cantilevered teeth 98.

The cantilevered teeth 98 are pivotable about a cantilever axis 102 to facilitate entering and exiting the sockets 100. Illustratively, the cantilever axis 102 is disposed at proximal ends 104 of the cantilevered teeth 98 that couples to the remainder of the connector 58 (also referred to as a connector body 106), and the cantilever axis 102 may be substantially perpendicular (that is, perpendicular ±10 degrees) to the detachment direction 92 and the attachment direction 94. Opposite the cantilever axis 102 and the proximal ends 104, the cantilevered teeth 98 include upstanding distal ends 108 that engage the sockets 100. Illustratively, the distal ends 108 include triangular shapes having apexes 110. Similarly, the sockets 100 may have the inverse shape of the distal ends 108 of the cantilevered teeth 98, specifically inverse triangular shapes having inverse apexes 112, for receiving the distal ends 108 of the cantilevered teeth 98. Alternatively, one or both of the distal ends 108 of the cantilevered teeth 98 and the sockets 100 may have non-triangular shapes. Illustratively, the distal ends 108 of the cantilevered teeth 98 and the sockets 100 may have uniform shapes in a second or transverse direction 114 substantially parallel (that is, parallel ±10 degrees) to the cantilever axis 102 and substantially perpendicular to the detachment direction 92. More specifically, the apexes 110 of the cantilevered teeth 98 and/or the inverse apexes 112 of the sockets 100 may extend in the transverse direction 114.

The shape of the distal ends 108 of the cantilevered teeth 98 and the shape of the sockets 100 facilitate securing the connector 58 to the base 56 unless a user applies a force to the connector 58 that exceeds a nominal threshold. More specifically, the cantilevered teeth 98 pivot about the cantilever axis 102 and slide relative to the sockets 100 and, as a result the connector 58 slides relative to the base 56, when a force applied in the detachment direction 92 or the attachment direction 94 exceeds the threshold. In some embodiments, the threshold is the same when applying the force in the detachment direction 92 or the attachment direction 94. In other embodiments, the threshold is different when applying the force in the detachment direction 92 or the attachment direction 94. In some embodiments, the threshold is less than about 20 N. In some embodiments, the threshold is about 0.5 N.

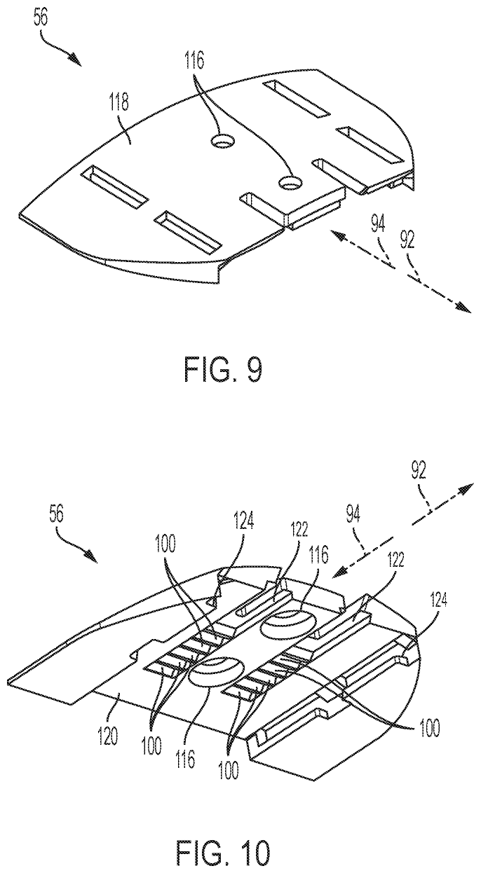

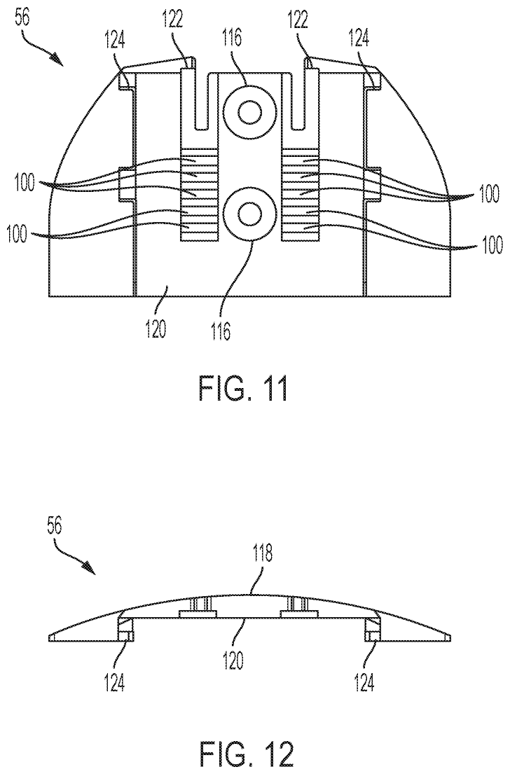

Referring now to FIGS. 9-12, the base 56 of the connecting structure 96 is illustrated. In various embodiments, the base 56 may generally be made from a resilient and lightweight material, such as plastic. In an exemplary embodiment, the base 56 is molded as a unitary or monolithic component. The base 56 is generally configured to couple to the lower surface 24 of the brim 14 of the head covering 10 (shown elsewhere). More specifically, the base 56 may include one or more attachment apertures 116 that are configured to receive fasteners 26 (shown elsewhere) for coupling the base 56 to the brim 14 of the head covering 10 (shown elsewhere). Illustratively, the base 56 includes two attachment apertures 116 that are disposed apart in the detachment direction 92 and the attachment direction 94. Alternatively and as described in further detail below, the base 56 may include different arrangements of attachment apertures 116. The base 56 may also include an arcuate upper surface 118 that is configured to engage the lower surface 24 of the brim 14 of the head covering 10 (shown elsewhere). More specifically, the arcuate upper surface 118 of the base 56 may have a convex shape to conform to the concave shape of the lower surface 24 of the brim 14 of the head covering 10.

An opposite lower surface 120 of the base 56 defines the sockets 100. The base 56 illustratively includes two sets of sockets 100, and each set illustratively includes five sockets 100. The sockets 100 in each set are disposed adjacent to each other in the detachment direction 92 and the attachment direction 94. Accordingly, the cantilevered teeth 98 of the connector 58 (shown elsewhere) may be received in different sockets 100 to facilitate repositioning the eyeshield 52 (shown elsewhere) relative to the front edge 20 of the brim 14 of the head covering 10 (shown elsewhere), for example, based on user preference. In some embodiments, the base 56 may include a different number of sets of sockets 100, and/or each set may include a different number of sockets 100. Illustratively, each set of sockets 100 couples to an adjacent socket slot 122 through which the distal end 108 of one of the cantilevered teeth 98 slide when the connector 58 attaches to or detaches from the base 56.

With continued reference to FIGS. 9-12, the lower surface 120 of the base 56 also defines two slider tracks or supports 124 that are configured to slidably receive the connector 58. More specifically, the slider supports 124 facilitate translation of the connector 58 in the attachment direction 94 and the detachment direction 92 relative to the base 56.

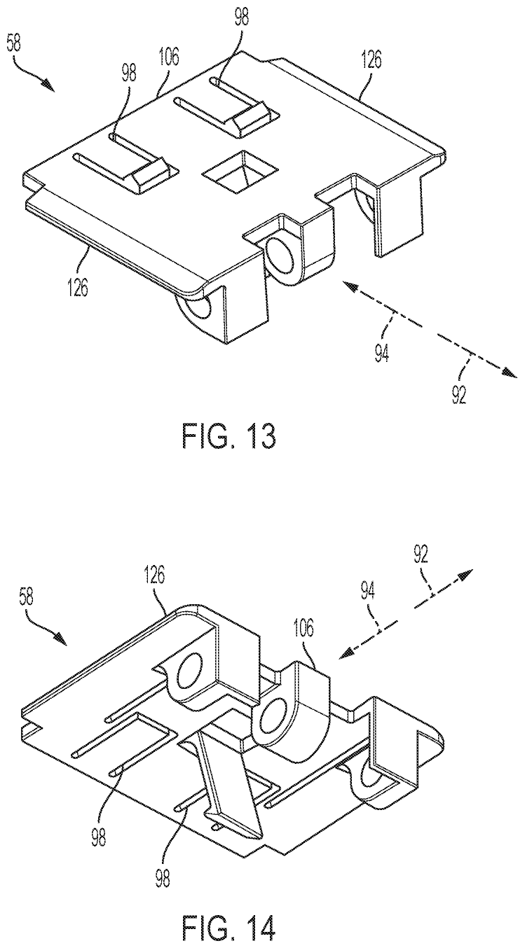

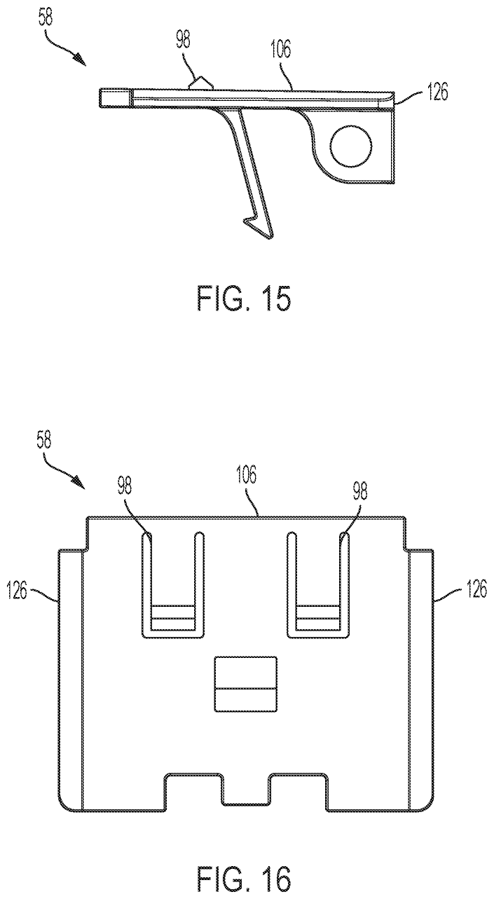

Referring now to FIGS. 13-16, the connector 58 of the connecting structure 96 is illustrated. In various embodiments, the connector 58 may generally be made from a resilient and lightweight material, such as plastic. In an exemplary embodiment, the connector 58 is molded as a unitary or monolithic component. The connector 58 includes a cantilevered tooth 98 for each set of sockets 100 defined by the base 56 (shown elsewhere). Illustratively, the connector 58 includes two cantilevered teeth 98. Sides of the connector body 106 include slider supports 126 that are configured to slidably couple the connector 58 to the base 56. More specifically, the slider supports 126 of the connector 58 slidably engage the slider supports 124 of the base 56 to facilitate translation of the connector 58 in the attachment direction 94 and the detachment direction 92 relative to the base 56.

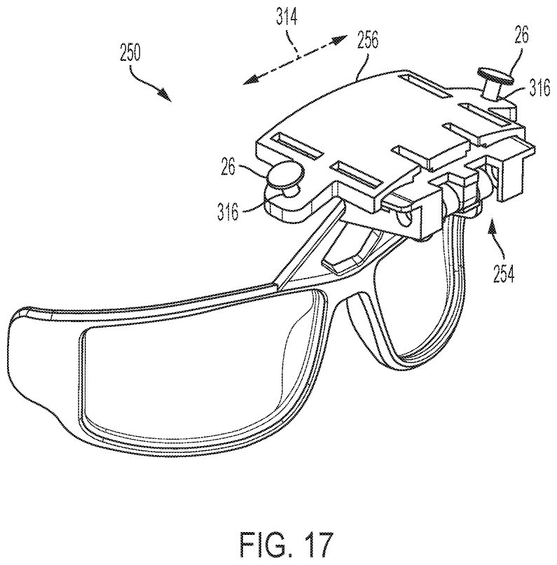

Referring now to FIG. 17, another embodiment of an eyeshield assembly 250 according to the present disclosure is illustrated. The eyeshield assembly 250 includes many of the same features and components as the eyeshield assembly 50 described above. As such, in the following description, like features and components are identified with similar reference numbers. The eyeshield assembly 250 includes a quick-connector device 254 having a different base 256 than the eyeshield assembly 50 described above. The base 256 is generally similar to the base 256 of the eyeshield assembly 50, except that the base 256 includes two attachment apertures 316 that are disposed apart in the transverse direction 314. The attachment apertures 316 receive fasteners 26 for coupling the base 256 and, as a result, the eyeshield assembly 250 to the brim 14 of the head covering 10 (shown elsewhere).

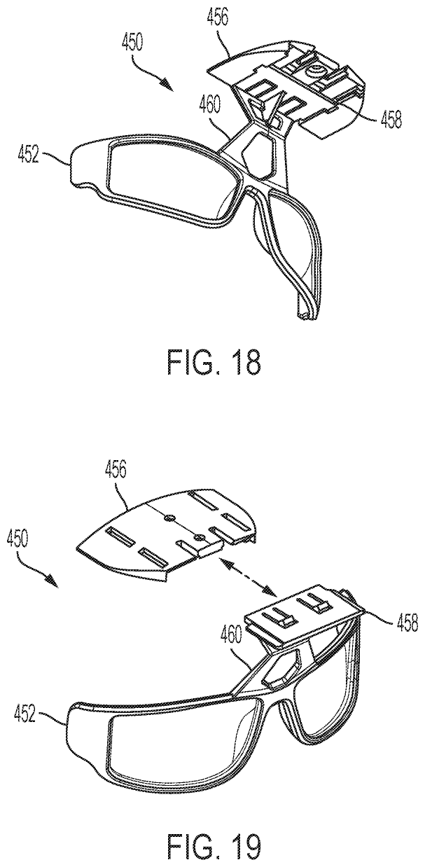

Referring now to FIGS. 18-19, yet another embodiment of an eyeshield assembly 450 according to the present disclosure is illustrated. The eyeshield assembly 450 includes many of the same features and components as the eyeshield assembly 50 described above. As such, in the following description, like features and components are identified with similar reference numbers. The eyeshield assembly 450 includes a connector 458 and an eyeshield 452 that differ from those of the eyeshield assembly 50 described above. Specifically, the eyeshield 452 non-pivotably couples to the connector 458 via a non-pivoting arm 460. More specifically, the eyeshield 452, the non-pivoting arm 460, and the connector 458 may be molded as a unitary or monolithic component. As a result, the eyeshield 452 may occupy a use position in the user's line of sight by coupling to the head covering (shown elsewhere) via the non-pivoting arm 460, the connector 458, and the base 456, but the eyeshield 452 does not pivot from the use position to a non-use position apart from the user's line of sight.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

Furthermore, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An eyeshield assembly configured to couple to a brim of a head covering, the eyeshield assembly comprising:
a base configured to couple to the brim of the head covering;
a connector detachably coupled to the base;
an eyeshield coupled to the connector;
a connecting structure detachably coupling the connector to the base, the connecting structure comprising:
a cantilevered tooth coupled to one of the base and the connector; and
a socket coupled to the other of the base and the connector, the socket selectively receiving the cantilevered tooth to secure the connector to the base.

2. The eyeshield assembly of claim 1, wherein the connector couples to the cantilevered tooth and the socket couples to the base.

3. The eyeshield assembly of claim 1, wherein the cantilevered tooth exits the socket and the connector slidably detaches from the base when a detachment force exceeds a threshold.

4. The eyeshield assembly of claim 1, wherein the connector is slidably detachable from the base by translating in a first direction, the cantilevered tooth is pivotable relative to the one of the base and the connector about an axis, and the axis is substantially perpendicular to the first direction.

5. The eyeshield assembly of claim 4, wherein the cantilevered tooth exits the socket and the connector slidably detaches from the base when a detachment force applied in the first direction exceeds a threshold.

6. The eyeshield assembly of claim 1, wherein the cantilevered tooth comprises an apex, the socket selectively receiving the apex to secure the connector to the base.

7. The eyeshield assembly of claim 1, further comprising a plurality of sockets including the socket, each of the plurality of sockets individually selectively receiving the cantilevered tooth to secure the connector to the base.

8. An eyeshield assembly for selectively coupling to a base, the base configured to couple to a brim of a head covering, and the base comprising a socket, the eyeshield assembly comprising:
an eyeshield;
a connector coupled to the eyeshield and configured to detachably couple to the base, the connector comprising:
a connector body;
a slider support coupled to the connector body, the slider support configured to slidably couple the connector to the base; and
a cantilevered tooth coupled to the connector body, the cantilevered tooth configured to be selectively received in the socket to secure the connector to the base.

9. The eyeshield assembly of claim 8, wherein the cantilevered tooth comprises an apex, the apex configured to be selectively received in the socket to secure the connector to the base.

10. The eyeshield assembly of claim 9, wherein the connector is configured to slidably detach from the base by translating in a first direction, and the apex extends in a second direction substantially perpendicular to the first direction.

11. The eyeshield assembly of claim 8, wherein the connector is configured to slidably detach from the base by translating in a first direction, the cantilevered tooth is pivotable relative to the connector body about an axis, and the axis is substantially perpendicular to the first direction.

12. A base for an eyeshield assembly configured to couple to a brim of a head covering, the eyeshield assembly comprising a connector coupled to an eyeshield, and the connector comprising a cantilevered tooth, the base comprising:
an attachment aperture configured to receive a fastener for coupling the base to the brim of the head covering;
a slider support configured to slidably receive the connector; and
a socket configured to selectively receive the cantilevered tooth of the connector to secure the connector to the base.

13. The base of claim 12, wherein the socket comprises an inverse apex.

14. The base of claim 13, wherein the slider support facilitates translation of the connector in a first direction relative to the base, and the inverse apex extends in a second direction substantially perpendicular to the first direction.

15. The base of claim 12, further comprising a plurality of sockets including the socket, each of the plurality of sockets configured to individually selectively receive the cantilevered tooth to secure the connector to the base.

16. The base of claim 12, further comprising an arcuate upper surface configured to engage a lower surface of the brim of the head covering.
